(19) United States
(12) Patent Application Publication
(10) Pub. No.: US 2005/0253774 A1
(43) Pub. Date: Nov. 17, 2005

(54) Multi-display system and display apparatus

(76) Inventor: Dong-Hoon Choi, Suwon-si (KR)

Correspondence Address: STANZIONE & KIM, LLP, 919 18TH STREET, N.W., SUITE 440, WASHINGTON, DC, 20006, US

(21) Appl. No.: 11/125,162

(22) Filed: May 10, 2005

(30) Foreign Application Priority Data
May 14, 2004 (KR) 2004-34064

(51) Int. Cl. G09G 5/00

(52) U.S. Cl. 345/1.1

(57) ABSTRACT

A multi-display system includes a plurality of display apparatuses capable of mutual data communication, and at least one of the plurality of display apparatuses receives predetermined control information from a user and transmits the control information to another display apparatus. The display apparatus can be remotely controlled without a central computer.

### CROSS-REFERENCE TO RELATED APPLICATIONS

This application claims the benefit of Korean Patent Application No. 2004-34064, filed May 14, 2004, in the Korean Intellectual Property Office, the disclosure of which is incorporated herein by reference.

### BACKGROUND OF THE INVENTION

1. Field of the Invention

The present invention relates to a multi-display system and a display apparatus, and particularly, to a display apparatus to be remotely controlled by another display apparatus without a central computer.

2. Description of the Related Art

A multi-display system indicates a plurality of display apparatuses located in several places throughout a wide range in order to provide visual information. Such a multi-display system has been widely used in establishments such as an airport, a department store, an exhibit hall, a hospital, a big wholesale market, etc.

FIG. 1 is a schematic block diagram of a conventional multi-display system used in a large-scale building.

As shown in FIG. 1, the multi-display system comprises a plurality of display apparatuses 101˜115, and a central computer 100.

The display apparatuses 101˜115 are scattered on each floor but connected to one another through a communication cable to be remotely controlled by the central computer 100 located on the sixth floor.

That is, through the central computer 100, a user can remotely control the display apparatus 101˜115 to selectively provide visual information. Thus, the respective display apparatuses 101˜115 selectively display various information, such as a movie, an advertisement, a price list, shopping information, guide information, etc., according to their own places.

On the other hand, when a user wants to change a video source of the display apparatuses 101˜115, the central computer 100 readjusts the video source for the display apparatuses 101˜115 according to a preset routine.

As described above, the central computer 100 can remotely adjust display environments of the display apparatuses 101˜115, for example, the video source, a volume, a power, a picture quality, a picture-in-picture (PIP) function, etc. Further, the central computer 100 can readjusts the display environments according to a voluntary external interference.

However, the conventional multi-display system is inconvenient for a user because the user has to use the central computer 100 to remotely control the display apparatuses 101˜115. That is, in a case where the user wants to control the volume or the power of some display apparatuses on the first floor, the user goes to the respective display apparatuses on the first floor and directly adjusts the volume or the power thereof, or goes to the central computer 100 on the sixth floor and remotely adjusts the volume or the power thereof.

Further, to check a state of each of the display apparatuses 101˜115 after each of the display apparatuses 101˜115 is remotely controlled, the user has to check the scattered display apparatuses one by one. Also, when there is needed to readjust the display environments of the respective display apparatuses, the user has to go to the central computer 100 on the sixth floor.

### SUMMARY OF THE INVENTION

In order to solve the foregoing and/or other problems, it is an aspect of the present general inventive concept to provide a multi display system and a display apparatus which can be remotely controlled without a central computer.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a multi-display system comprising a plurality of display apparatuses capable of mutual data communication, wherein at least one display apparatus among the plurality of display apparatuses can receive predetermined control information from a user and can transmit the control information to another display apparatus.

According to an aspect of the present general inventive concept, at least one first display apparatus among the plurality of display apparatuses may comprise an input unit to receive the control information, a communication interface to communicate with at least one other display apparatus, and a controller to transmit at least one control instruction included in the control information to a target display apparatus through the communication interface when the control information includes distinctive information about the target display apparatus to be controlled remotely.

According to another aspect of the present general inventive concept, the multi-display system may further comprise at least one second display apparatus among the plurality of display apparatuses, the at least one second display apparatus comprising a communication interface to communicate with at least one other display apparatus, wherein the second display apparatus determines whether the second display apparatus itself is designated as the target display apparatus by analyzing the control information received from another display apparatus through the communication interface, implements the least one control instruction according to the control information when the second display apparatus is designated as the target display apparatus, and transmits the control information to another target display apparatus when the control information relates to the another target display apparatus.

According to yet another aspect of the present general inventive concept, the control information may include distinctive information about at least one target display apparatus to receive the control information.

According to still another aspect of the present general inventive concept, the multi-display system may further comprise a central computer to control the plurality of display apparatuses.

According to another aspect of the present general inventive concept, the plurality of display apparatuses are partially connected in series, and the control information is in turn received and transmitted among the display apparatuses connected in series.

The foregoing and/or other aspects and advantages of the present general inventive concept may also be achieved by providing, a display apparatus used with a multi-display system, the display apparatus comprising a communication interface to be connected with at least one external display apparatus, an input unit to receive predetermined control information, and a controller to transmit at least one control instruction included in the control information to a target display apparatus designated by the control information through the communication interface.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic block diagram of a conventional multi-display system used in a large-scale building;

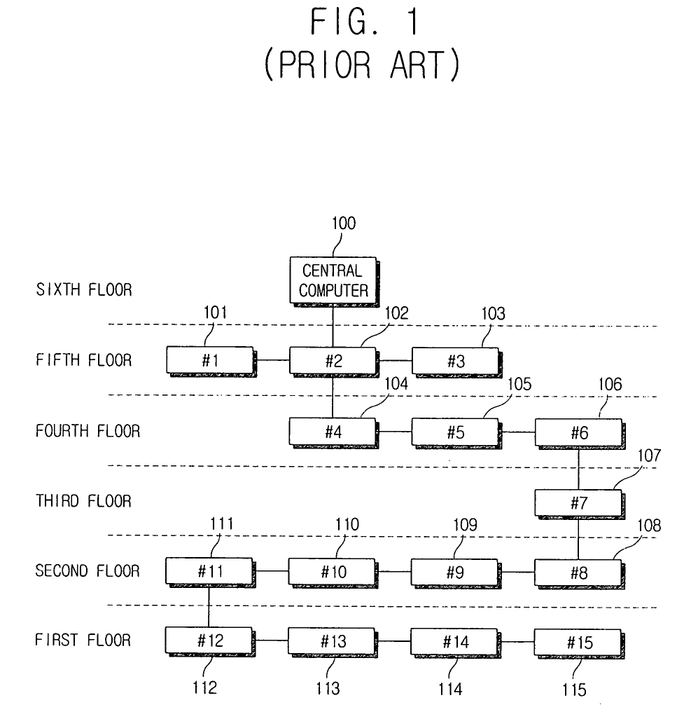

FIG. 2 is a schematic block diagram of a multi-display system according to an embodiment of the present general inventive concept;

FIG. 3 is a control flowchart of a method of processing control information in a multi-display system according to another embodiment of the present general inventive concept; and

FIG. 4 is a schematic block diagram of a display apparatus used with a multi-display system according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present invention by referring to the figures.

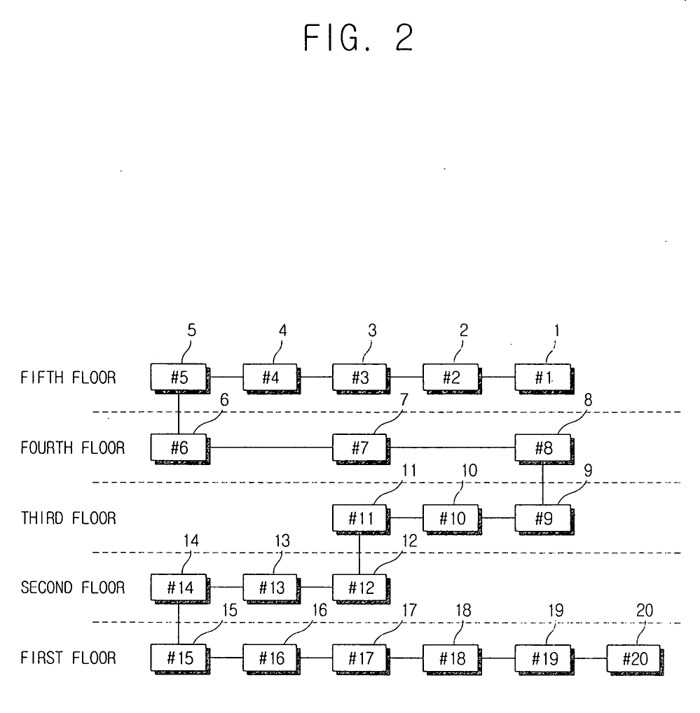

FIG. 2 is a schematic block diagram of a multi-display system according to an embodiment of the present general inventive concept.

As shown in FIG. 2, the multi-display system may comprise a plurality of display apparatuses 1˜20 which are connected to one another for mutual communication.

The plurality of display apparatuses 1˜12 can be connected in series through a serial communication interface, such as RS232C. Here, each of the display apparatuses 1˜20 may have an inherent identification (ID) to be distinguished from other display apparatuses.

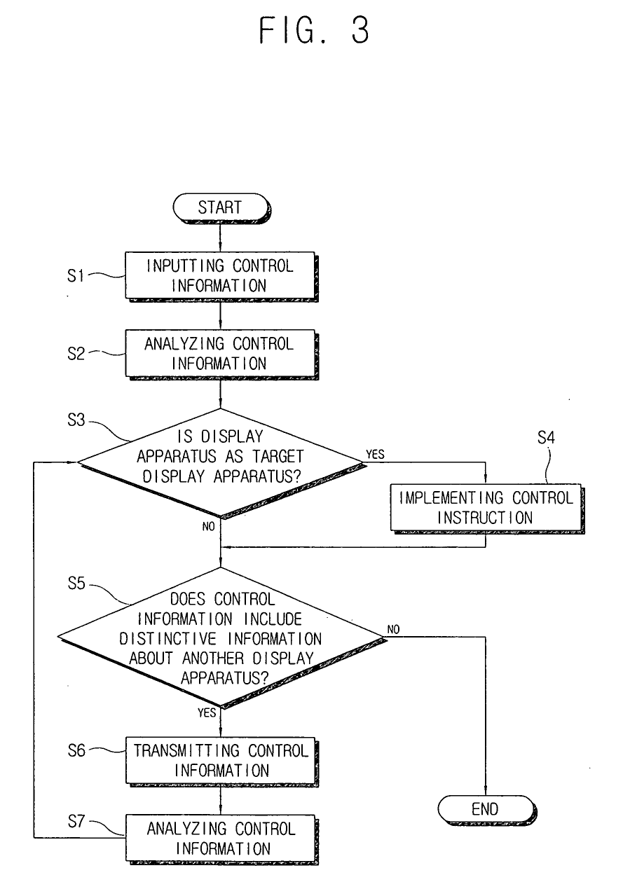

FIG. 3 is a control flowchart of a method of processing control information in a multi-display system according to another embodiment of the present general inventive concept.

Hereinbelow, the method of processing information of the multi-display system will be described with reference to FIGS. 2 and 3.

First, a user inputs control information to a predetermined display apparatus, which may be one of the plurality of display apparatuses 1˜20, in operation S1. Here, the control information may include distinctive information to distinguish the respective display apparatuses 1˜20, and control instruction information which can include an instruction to control at least one of display environments, such as a volume, a power on/off, a picture quality, a video source, a PIP function, etc. Further, the control instruction information may be different from one another according to target display apparatuses to be controlled.

In operation S2, the display apparatus can receive the control information from a user and can analyze the control information.

As a result of analyzing the control information, when the predetermined display apparatus itself receiving the control information is designated as one of the target display apparatuses in operation S3, the predetermined display apparatus can implement the control instruction according to the input control information in operation S4. Further, when the control information includes the distinctive information about another display apparatus (another one of the target display apparatuses) in operation S5, the predetermined display apparatus can transmit at least partial control instruction information of the received control information to the another display apparatus corresponding to the distinctive information in operation S6. The at least partial control instruction information may not include the control instruction corresponding to the predetermined display apparatus since the predetermined display apparatus has implemented the control instruction according to the input control information.

Here, the distinctive information can be used for a group of the display apparatuses.

For example, a user can input the control information through the display apparatus 17 located on the first floor, and the control information may include the distinctive information for a group of five target display apparatuses 15 and 17˜20 located on the same floor, and the control instruction information about turning off the five target display apparatuses 15 and 17˜20.

Then, the display apparatus 17 can analyze the control information to determine whether its own ID is designated as that of one of the target display apparatuses 15 and 17˜20, and which one of the display apparatuses is designated as one of the target display apparatuses 15 and 17˜20. Because the control information includes the distinctive information about the display apparatuses 15 and 17˜20, the display apparatus 17 can not only implement the control instruction of turning itself off but also transmit the control information toward the target display apparatuses 15 and 18˜20.

Then, other display apparatuses can receive the control information from the display apparatus 17 and can analyze the distinctive information in operation S7, thereby determining whether their own IDs are designated as those of the target display apparatuses 15 and 17˜20, respectively. For example, the display apparatuses 16 and 18 can receive the control information from the display apparatus 17 and can determine whether they are determined as the target display apparatuses 15 and 17˜20 according to the control information.

In a case where the display apparatus receiving the control information is not designated as one of the target display apparatuses 15 and 17˜20, the display apparatus can skip over the control information and can transmit the control information to a next display apparatus. That is, since the display apparatus 16 is not designated as one of the target display apparatuses 15 and 17˜20, the control information can be skipped in the display apparatus 16 and can be transmitted to the display apparatus 15.

In a case where the display apparatus receiving the control information is designated as one of the target display apparatuses 15 and 17˜20, the display apparatus can analyze the control instruction information of the control information and can correspondingly implement the control instruction in operation S4. Particularly, in a case where the control instruction information includes the control instructions which are different according to the target display apparatuses 15 and 17˜20, the target display apparatuses 15 and 17˜20 implement specific control instructions designated thereto, respectively. At this time, when the control information further relates to another target display apparatus, the display apparatus can transmit the control information to another display apparatus in operation S6. For example, the display apparatus 18 can transmit the control information to the display apparatus 19 and can implement the control instruction of turning itself off. Further, in a case where the control instruction information includes different control instructions designated to the respective display apparatuses 18 and 19, each display apparatus 18 or 19 can analyze the corresponding control instruction information and can implement the specific control instruction designated thereto.

Thus, a remote control through the above-described display apparatus is very effective in monitoring states of other display apparatuses located in the same range. Alternatively, the multi-display system according to an aspect of the present general inventive concept may further comprise a central computer connected to the display apparatuses. In this case, a user can remotely manage the whole multi-display system through the central computer as well as the display apparatus.

The multi-display system shown in FIG. 2 can employ a serial communication method of connecting the display apparatuses to one another, but several display apparatuses may be connected to one display apparatus. When several display apparatuses may be connected to one display apparatus, the display apparatus receiving the control information may comprise a data communication channel, such as a router, to transmit the control information to the target display apparatus.

In an aspect of the present general inventive concept, the control information can be transmitted from the display apparatus 9 to a first group of the display apparatuses, for example, the display apparatus 1-8, and a second group of the display apparatuses, for example, the display apparatuses 10-20 when the control information is inputted to the display apparatus 9. Therefore, each of the display apparatuses 1-20 may communicate with other display apparatuses 1-20 through mutual data communication (bidirectional communication). In another example, the control information can be transmitted from the display apparatus 1 to the display apparatus 20 or from the display apparatus 20 to the display apparatus 1 through other display apparatuses 2-19.

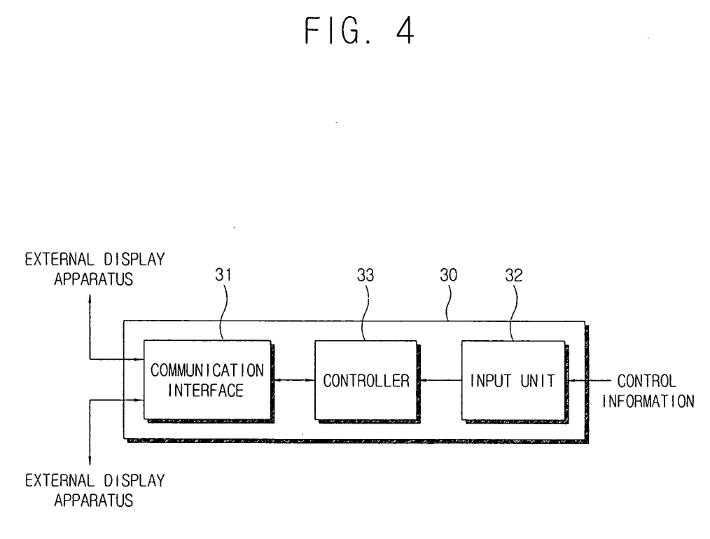

FIG. 4 is a schematic block diagram of a display apparatus according to another embodiment of the present general inventive concept.

As shown in FIG. 4, at least one first display apparatus 30 forming the multi-display system may comprise a communication interface 31, an input unit 32, and a controller 33.

The communication interface 31 can allow the first display apparatus 30 to be connected with at least one of other display apparatuses for data communication. That is, the communication interface 31 may comprise at least one serial communication interface, such as RS232C, or at least one parallel communication interface.

The input unit 32 may comprise a hardware component, such as a remote controller, a control panel, etc., or a software component, such as an on screen display (OSD) program, etc., to receive the control information. Through the input unit 32, a user can input the distinctive information to designate at least one display apparatus as the target display apparatus, and the control instruction information. Here, the distinctive information can be used for a group of the display apparatuses.

The controller 33 may analyze the control information received from the input unit 32 and can transmit the control information to the target display apparatus. Here, the control information may include the distinctive information to distinguish the target display apparatus from other display apparatuses, and the control instruction information having the control instruction to be implemented by the target display apparatus.

When the target display apparatus is not directly connected with the first display apparatus 30, the control information can be transmitted from the first display apparatus 30 to the target display apparatus via another display apparatuses. The display apparatus receiving the control information can compare its own ID with the distinctive information of the control information. When the display apparatus itself receiving the control information is designated as the target display apparatus, the display apparatus can implement the control instruction according to the control instruction information of the control information. That is, the display apparatus performs an operation corresponding to the control instruction.

Further, when the display apparatus receiving the control information is not designated as the target display apparatus or when the control information includes the distinctive information about another display apparatus, the display apparatus can transmit the control information toward the target display apparatus.

On the other hand, in the multi-display system according to an aspect of the present general inventive concept, the number of the first display apparatus 30 for the remote control may be limited. In this case, a second display apparatus except for the first display apparatus 30 may comprise the communication interface 31 and the controller 33 without the input unit 32, thereby analyzing the received control information, controlling itself, forwarding the received control information to the next display apparatus, etc.

Thus, the display apparatuses for the remote control among the plurality of display apparatuses forming the multi-display system can be located in the right places and properly controlled, thereby economically and effectively managing the multi-display system.

As described above, the present general inventive concept can provide a multi-display system and a display apparatus, which are convenient for a user to remotely control the multi-display system.

Although a few embodiments of the present general inventive concept have been shown and described, it will be appreciated by those skilled in the art that changes may be made in these embodiments without departing from the principles and spirit of the invention, the scope of which is defined in the appended claims and their equivalents.

1. A multi-display system comprising:
a plurality of display apparatuses connected through mutual data communication, wherein at least one of the plurality of display apparatuses receives predetermined control information from a user and transmits the control information to another one of the plurality of display apparatuses.

2. The multi-display system of claim 1, wherein the at least one display apparatus comprises:
an input unit to receive the control information having distinctive information on a target display apparatus, and a control instruction corresponding to a characteristic of the target display apparatus;
a communication interface to communicate with the another one of the plurality of display apparatuses; and
a controller to transmits at least one control instruction included in the control information to the target display apparatus through the communication interface.

3. The multi-display system of claim 1, wherein the plurality of display apparatuses comprise a second display apparatus comprising a communication interface to communicate with at least one display apparatus and the another one of the plurality of display apparatuses to receive the control information, wherein the second display apparatus determines whether the second display apparatus itself is designated as the target display apparatus by analyzing the control information received from the at least one display apparatus through the communication interface, implements the control instruction according to the control information when the second display apparatus is designated as the target display apparatus, and transmits the control information to the another one of the plurality of display apparatus when the control information relates to the another one of the plurality of display apparatuses as the target display apparatus.

4. The multi-display system of claim 1, wherein the control information includes distinctive information about one or more target display apparatuses to receive the control information, and the control information is transmitted from the at least one display apparatus to the one or more target display apparatuses.

5. The multi-display system of claim 1, further comprising:
a central computer to control the plurality of display apparatuses,
wherein the control information is input from one of the central computer and the at least one of the plurality of display apparatuses.

6. The multi-display system of claim 1, wherein the plurality of display apparatuses comprise a group of the display apparatuses connected in series, and the control information is received and transmitted among the group of the display apparatuses connected in series.

7. The multi-display system of claim 1, wherein each of the plurality of display apparatuses comprises an ID, and the control information comprises distinctive information on the ID, and control instruction information on a display environment corresponding to one of the plurality of display apparatuses having the ID.

8. The multi-display system of claim 7, wherein the display environment of the control instruction information comprises one of a volume, a power on/off, a picture quality, a video source, and a PIP function, and the display environment corresponds to at least one of the plurality of display apparatus including the first display apparatus.

9. The multi-display system of claim 1, wherein the control information comprises distinctive information corresponding to one or more target display apparatuses of the plurality of display apparatuses, and a control instruction corresponding to one or more display environments of the one or more target display apparatuses, and the at least one of the plurality of display apparatuses determines whether the at least one of the plurality of display apparatuses is one of the one or more target display apparatus.

10. The multi-display system of claim 9, wherein the one or more display environments are different according to the one or more target display apparatuses.

11. The multi-display system of claim 9, wherein the plurality of display apparatuses comprise a second display apparatus connected to the at least one of the plurality of display apparatuses, and the second display apparatus implements a corresponding one of the one or more display environments when the second display apparatus is the one or more target display apparatus.

12. The multi-display system of claim 9, wherein the plurality of display apparatuses comprise a second and a third display apparatuses connected to the at least one of the plurality of the display apparatuses, and the second display apparatus transmits the control information to the third display apparatus when the second display apparatus is not the one or more target display apparatuses.

13. The multi-display system of claim 9, wherein the plurality of display apparatuses comprise a second and a third display apparatus, and the second display apparatus transmits the control information, which excludes the distinction information on the second display apparatus, to the third display apparatus when implementing a corresponding one of the one or more display environments.

14. The multi-display system of claim 9, wherein the one or more target display apparatuses comprise a first and a second target display apparatuses, and the one or more display environments comprise a first and a second display environments to correspond to the first and second target display apparatuses, respectively, and the first display environment is different from the second display environment.

15. The multi-display system of claim 14, wherein the first display environment comprises at least one of a first volume, a first power on/off, a first picture quality, a first video source, and a first PIP function, and the second display environment comprise at least one of a second volume, a second power on/off, a second picture quality, a second video source, and a second PIP function.

16. The multi-display system of claim 9, wherein the at least one of the plurality of display apparatuses comprises a hardware component and a software component to receive the control information to control the plurality of display apparatuses, and the hardware component and the software component comprise at least one of a remote controller, a control panel, and an OSD program to display a menu to receive the control information.

17. The multi-display system of claim 1, wherein the plurality of display apparatuses comprise a first group of display apparatuses and a second group of display apparatuses connected to both sides of the at least one of the plurality of display apparatuses, and the at least one of the plurality of display apparatuses transmits the predetermined control information to the first group of display apparatuses and the second group of display apparatuses.

18. A display apparatus used with a multi-display system, comprising:
a communication interface to be connected with at least one external display apparatus;
an input unit to receive predetermined control information; and
a controller to transmit at least one control instruction included in the control information to the at least one external display apparatus corresponding to at least one target display apparatus designated by the predetermined control information through the communication interface.

19. The display apparatus of claim 18, wherein the control information comprises distinctive information corresponding to the at least one target display apparatus, and a control instruction corresponding to one or more display environments of the target display apparatus, and the controller implements the control instruction when the controller corresponds to the distinctive information of the at least one target display apparatus.

20. The display apparatus of claim 18, wherein the at least one target display apparatus comprises a first target display apparatus and a second target display apparatus, the control information comprises first distinctive information corresponding to the first target display apparatus, second distinctive information corresponding to the second target display apparatus, a first control instruction corresponding to one or more first display environments of the first target display apparatus, and a second control instruction corresponding to one or more second display environments of the second target display apparatus, and the controller implements the first control instruction of the control information when the controller corresponds to the first distinctive information of the first target display apparatus.

21. The display apparatus of claim 20, wherein the controller transmits the second distinctive information and the second control instruction to the at least one external display apparatus corresponding to the second target display apparatus as the at least one control instruction included in the control information.

22. The display apparatus of claim 18, further comprising:
a hardware component and a software component to receive the predetermined control information to control the at least one target display apparatus,
wherein the hardware component comprises at least one of a remote controller and a control panel, and the software component comprises an OSD program to display a menu to receive the predetermined control information relating to the at least one target display apparatus.
